(19) United States
(12) Patent Application Publication
(10) Pub. No.: US 2006/0146091 A1
(43) Pub. Date: Jul. 6, 2006

(54) Methods for reducing deformations of films in micro-fluid ejection devices

(76) Inventors: Craig M. Bertelsen, Union, KY (US); Brian C. Hart, Georgetown, KY (US); Gary A. Holt JR., Lexington, KY (US); Sean T. Weaver, Union, KY (US); Gary R. Williams, Lexington, KY (US); Girish S. Patil, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/027,705

(22) Filed: Dec. 30, 2004

(51) Int. Cl. B41J 2/14; B41J 2/16

(52) U.S. Cl. 347/47

(57) ABSTRACT

A method of making a micro-fluid ejection head structure. The method can include positioning a semiconductor substrate having a fluid feed slot over a nozzle plate film in a bonding orientation therewith such that the substrate overlies the nozzle plate film and the device side of the substrate is substantially downwardly facing so that gravitational forces inhibit deformation of portions of the nozzle plate film toward the device side of the substrate.

### FIELD

The disclosure relates to micro-fluid ejection devices, and in particular to improved methods for making micro-fluid ejection head structures.

### BACKGROUND

Micro-fluid ejection heads are useful for ejecting a variety of fluids including inks, cooling fluids, pharmaceuticals, lubricants and the like. A widely used micro-fluid ejection head is in an ink jet printer. Ink jet printers continue to be improved as the technology for making the micro-fluid ejection heads continues to advance. New techniques are constantly being developed to provide low cost, highly reliable printers which approach the speed and quality of laser printers. An added benefit of ink jet printers is that color images can be produced at a fraction of the cost of laser printers with as good or better quality than laser printers. All of the foregoing benefits exhibited by ink jet printers have also increased the competitiveness of suppliers to provide comparable printers in a more cost efficient manner than their competitors.

One area of improvement in the printers is in the print engine or micro-fluid ejection head itself. This seemingly simple device is a relatively complicated structure containing electrical circuits, ink passageways and a variety of tiny parts assembled with precision to provide a powerful, yet versatile micro-fluid ejection head. The components of the ejection head must cooperate with each other and with a variety of ink formulations to provide the desired print properties. Accordingly, it is important to match the ejection head components to the ink and the duty cycle demanded by the printer. Slight variations in production quality can have a tremendous influence on the product yield and resulting printer performance.

### SUMMARY OF THE EMBODIMENTS

In an exemplary embodiment, the disclosure provides a method of making a micro-fluid ejection head structure. Such a method can include positioning a semiconductor substrate having a fluid feed slot over a nozzle plate film in a bonding orientation therewith such that the substrate overlies the nozzle plate film and the device side of the substrate is substantially downwardly facing so that gravitational forces inhibit deformation of portions of the nozzle plate film toward the device side of the substrate.

In another embodiment, there is provided a method of bonding a deformable film to a fluid flow structure in order to inhibit blocking of flow paths in the fluid flow structure. The method can include applying the fluid flow structure to the deformable film by substantially downward movement of the fluid flow structure toward the film. During the downward movement of the structure gravitational forces inhibit deformation of portions of the film into portions of the flow paths of the fluid flow structure sufficient. The film is then bonded to the structure.

An advantage of at least some of the embodiments described herein can be that sagging and other deformations of a nozzle plate film into slots or flow feature areas of the structure, as occurs with other techniques, is substantially avoided.

### BRIEF DESCRIPTION OF THE DRAWINGS

Further features and advantages of the disclosed embodiments will become apparent by reference to the detailed description when considered in conjunction with the figures, which are not to scale, wherein like reference numbers indicate like elements through the several views, and wherein:

FIGS. 1A-1C are cross-sectional views, not to scale, showing steps in one approach to the manufacture of a micro-fluid ejection head;

FIG. 2 is a cross-sectional view, not to scale, of a micro-fluid ejection head;

FIG. 3 depicts lamination of a dry film onto a substrate/flow feature layer in accordance with an exemplary embodiment of the disclosure;

FIG. 4 depicts lamination of a dry film onto a substrate/flow feature layer in accordance with another embodiment of the disclosure; and

FIG. 5 depicts lamination of a dry film onto a substrate/flow feature layer in accordance with yet another embodiment of the disclosure.

### DETAILED DESCRIPTION OF THE EXEMPLARY EMBODIMENTS

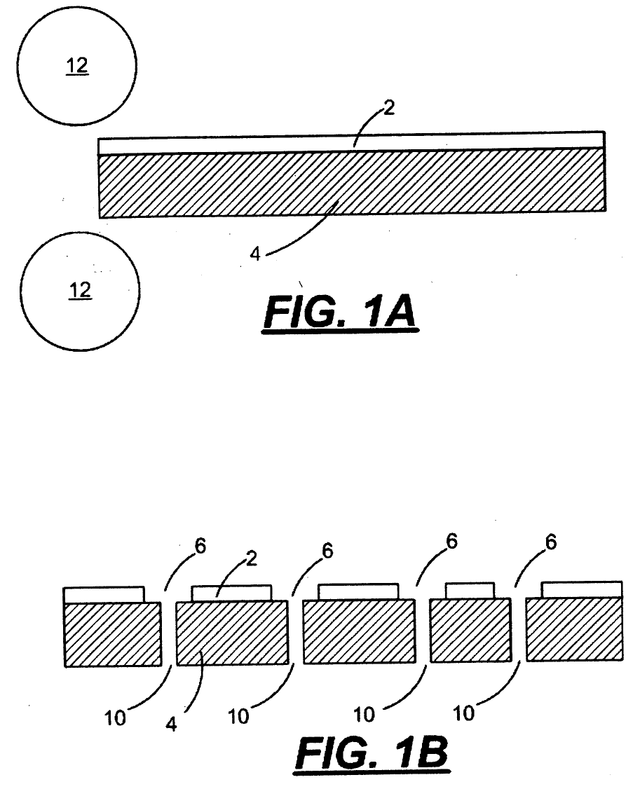

The invention relates to improvements in the manufacture of micro-fluid ejection head of the type having a nozzle plate provided by a film having nozzle holes formed thereon and applied over fluid supply slots defined in a semiconductor substrate. For example, with reference to FIGS. 1A-1C, there are shown simplified representations of one possible approach to manufacturing micro-fluid ejection heads.

In a first step (FIG. 1A), a photoimageable layer 2 is provided on a semiconductor substrate 4. In a second step (FIG. 1B), fluid chambers and fluid channels, collectively referred to as “flow features” 6, are formed in the photoimageable layer 2. In a third step (FIG. 1C), a nozzle plate film 8 having nozzle holes defined therethrough is applied over the layer 2. Fluid feed slots 10 can be provided at desired locations through the substrate 4 either before or after installation of the film 8 for supplying fluid from a fluid supply to the flow features 6 for ejection through the nozzle holes in the nozzle plate film 8.

The semiconductor substrate 4 is generally made of silicon and contains various passivation layers, conductive metal layers, resistive layers, insulative layers and protective layers deposited on a device surface thereof. Fluid ejection actuators formed on the device surface of the substrate 4 may be thermal actuators or piezoelectric actuators. For thermal actuators, individual heater resistors are defined in the resistive layers and each heater resistor corresponds to a nozzle hole in the nozzle plate film 8 for heating and ejecting fluid from the ejection head toward a desired medium or target.

In this regard, the photoimageable layer 2 can be either a positive or negative photoresist material applied as a wet layer as by spin coating, spray coating or the like, or as provided by a dry film photoresist material. In the case of a dry film photoresist material to provide the layer 2, the substrate 4 having the layer 2 thereon can be passed between heated rollers 12 of a hot roll laminator (FIG. 1A) to bond the layer 2 to the substrate 4. The photoimageable layer 2 can then be exposed, as by use of a photomask, and developed to form the flow features 6 therein (FIG. 1B).

The nozzle plate film 8 may also be a dry film photoresist material which may include one or more layers of photoresist material and may be imaged through a photomask and developed to form the nozzle holes. The film 8 can be bonded to the layer 2 by passing the film/layer/substrate 8/2/4 composite between heated rollers 14 of a hot roll laminator (FIG. 1C). The photoresist material may act as an adhesive or an adhesive may be provided on the film 8 for bonding to the layer 2.

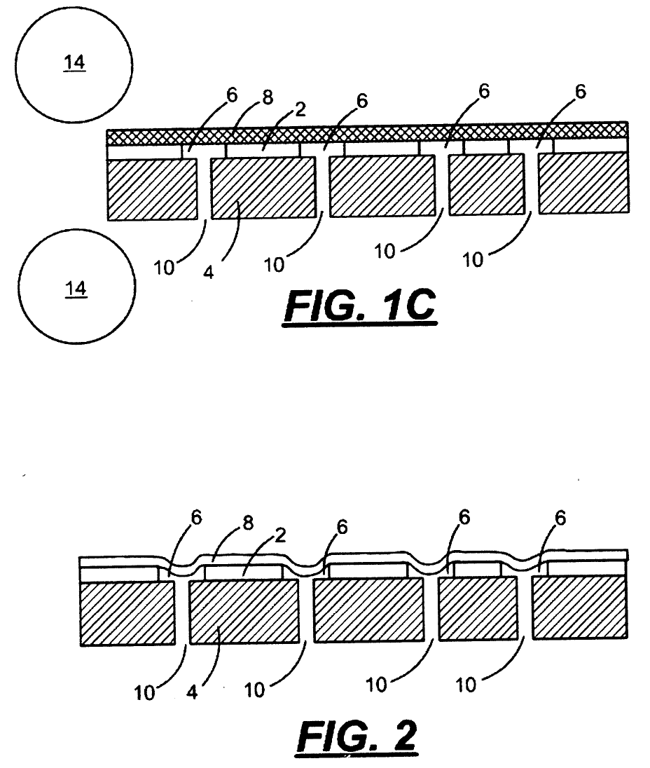

A problem associated with the aforementioned manufacturing technique(s), especially in the attachment of the nozzle plate film 8 as shown in FIG. 1C, is that the film 8 may deform or sag into the areas of the flow features 6 and/or the slots 10, as illustrated in FIG. 2. For example, if installation of the film 8 is performed prior to formation of the fluid feed slots 10, the film 8 can sag down and adhere to the substrate 4 in the area of the flow features 6. If the film 8 is installed after the slots 10 are formed (such as shown in FIG. 1C) the film 8 can sag and either adhere to the walls of the slots 10 or otherwise be significantly deformed to block fluid flow through the slots 10. Such an event is undesirable and can result in non-functional micro-fluid ejection heads or ejection heads that perform poorly.

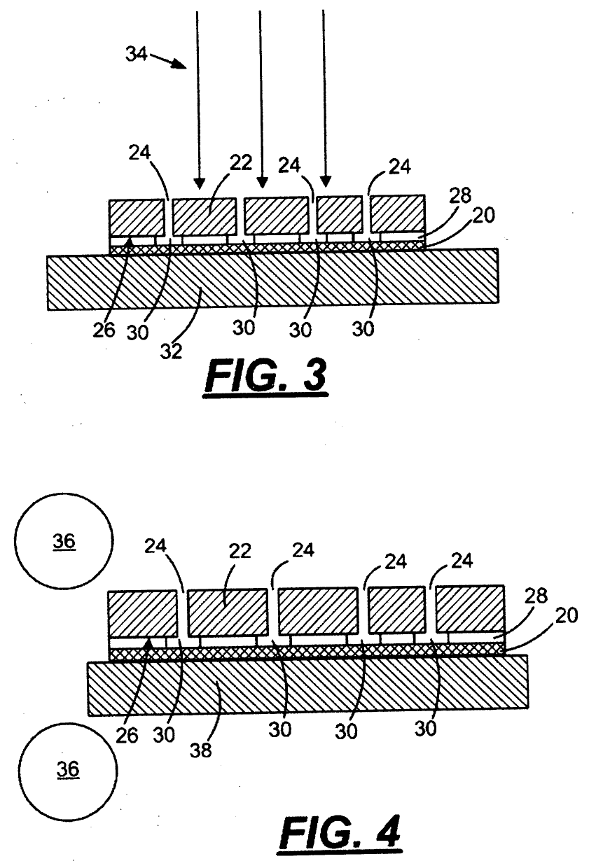

With reference to FIGS. 3-5, there will be described methods in accordance with exemplary embodiments of the disclosure for attaching nozzle plate films to an underlying semiconductor substrate having fluid feed slots provided therein.

For example, in FIG. 3 there is shown an exemplary method for attaching a nozzle plate film 20 to a semiconductor substrate 22 having fluid feed slots 24 defined therein. A device side 26 of the substrate 22 on which ejection actuator devices, such as heaters and the like, are formed may include a flow feature layer 28 containing flow features 30 such as fluid chambers and fluid flow channels therein.

The nozzle plate film 20 may be provided by a wide variety of materials that may be provided as a dry film for lamination to the substrate 22. Such materials, include but are not limited to epoxies, acrylates, polyimides and the like. Such films 20 are relatively thin and have a thickness ranging from about 5 to about 100 microns. In some exemplary embodiments, the nozzle plate film 20 contains only nozzle holes and a separate flow feature layer 28 is applied to the substrate to provide flow features 30, including fluid chambers and fluid flow channels for flow of fluid to ejection devices on the device side 26 of the substrate 22. In other embodiments, the nozzle plate film 20 has a thickness sufficient to provide nozzle holes and the flow features 30 therein.

In an exemplary embodiment, the nozzle plate film 20 is a dry film photoresist material which may be imaged through a photomask and developed to form nozzle holes therein. Typical dry film photoresist materials which may be used include, but are not limited to, photoresist materials available from E. I. DuPont de Nemours and Company of Wilmington, Del. under the trade names RISTON, EMS 314-98 from EMS, Inc. of Delaware, Ohio, and ORDYL PR100 from Tokyo Ohka Kobyo Co., LTD. Kanagawa, Japan which act as adhesive photoresist materials. In such an embodiment, the nozzle plate film 20 can be applied to the separate flow feature layer 28.

In another embodiment, the flow features 30 can be formed, as by photoresist methods, in the flow feature layer 28 attached to the device side 26 of the substrate 22. In such embodiment, the flow feature layer 28 may be provided by a positive or negative photoresist material applied to the substrate 22 as a wet layer by a spin coating process, a spray coating process, or the like, or the flow feature layer 28 may be applied to the substrate 22 as a dry film photoresist material. Examples of suitable photoresist materials, include but are not limited to acrylic, epoxy, and polyimide-based photoresists such as the photoresist materials available from Clariant Corporation of Somerville, N.J. under the trade names AZ4620 and AZ1512. Other photoresist materials are available from Shell Chemical Company of Houston, Tex. under the trade name EPON SU8 and photoresist materials available from Olin Hunt Specialty Products, Inc. which is a subsidiary of the Olin Corporation of West Paterson, N.J. under the trade name WAYCOAT. An example of a polyimide based photoresist is HD4000 from HD Microsystems of Parlin, N.J. A preferred photoresist material includes from about 10 to about 20 percent by weight difunctional epoxy compound, less than about 4.5 percent by weight multifunctional crosslinking epoxy compound, from about 1 to about 10 percent by weight photoinitiator capable of generating a cation and from about 20 to about 90 percent by weight non-photoreactive solvent as described in U.S. Pat. No. 5,907,333 to Patil et al., the disclosure of which is incorporated by reference herein as if fully set forth.

The flow features 30 may be formed in the flow feature layer 28 in a manner, such as described in connection with FIGS. 1A-1B. For example, the flow features 30 may be imaged in the flow feature layer 28 using ultraviolet light with wavelengths typically in the 193 to 450 nanometer range and developed using standard developing techniques. Hence, the flow feature layer 28 provides a variety of conventional flow feature defining structures such as fluid chamber and fluid channels located between the semiconductor substrate 22 and the nozzle plate film 20 of the structure, wherein the flow features 30 route fluid from the fluid feed slots 24 of the semiconductor substrate 22 to the ejection devices on the device side 26 of the substrate 22. Accordingly, the substrate/flow feature layer 22/28 may be virtually any conventionally prepared semiconductor/flow feature layer 22/28 structure.

The disclosure provides improved methods for applying the nozzle plate films 20 to the semiconductor substrate 22. As described above, the substrate 22 has one or more fluid feed slots 24 therein for flow of fluid to ejection actuator devices on the device side 26 of the substrate. The nozzle plate film 20 is applied to the flow feature layer 28 on the substrate 22 so that the nozzles of the nozzle plate film 20 are in flow communication with the fluid feed slots 24 in the substrate 22. The slots 24 may be formed in the substrate 22 prior to or after attachment of the film 20 to the flow feature layer 28.

In a first embodiment, a thermocompression bonder instead of a hot roll laminator is used to attach the substrate 22 with flow feature layer 28 thereon and nozzle plate film 20 to one another. The orientation of the substrate/flow feature layer 22/28 to the nozzle plate film 20 during the bonding step is shown in FIG. 3 wherein the substrate/flow feature layer 22/28 overlies the nozzle plate film 20. In such an embodiment, the nozzle plate film 20 is first placed on a support plate 32 of a thermocompression bonder. Next, the substrate/flow feature layer 22/28 is positioned over the film 20 so that the device side 26 of the substrate 22 is downwardly facing. Next, the thermocompression bonder is closed so that heat and pressure (represented by downwardly extending arrows 34) is applied to bond the substrate/flow feature layer 22/28 structure to the nozzle plate film 20. According to one exemplary embodiment, desired temperature and pressure conditions can be in the range of from about 40° to about 150° C. and from about 5 to about 80 psig. By performing lamination in this manner, it has been observed that the sagging and other deformations of the nozzle plate film 20 into the slots 24 and/or flow features 30, as occurs with other techniques, is substantially avoided. A modified heated hydraulic press from Carver, Inc. of Wabash, Ind. may be used as a thermocompression bonder.

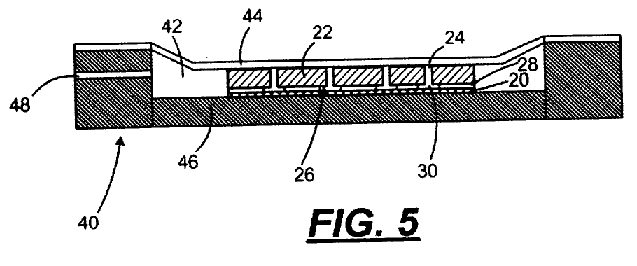

With reference to FIG. 4, there is illustrated an alternate method for laminating the film 20 to the substrate/flow feature layer 22/28. In this method, a conventional hot roll laminator having heated rollers 36 is used in conjunction with a support plate 38. The plate 38 can be substantially flat and has substantially the same shape as the substrate 22. The nozzle plate film 20 is first placed on the plate 38 and the substrate/flow feature layer 22/28 is positioned over the film 20 so that the device side 26 of the substrate 22 is downwardly facing. Next, the thus oriented composite 20/28/22 is processed through the heated rollers 36 of the roll laminator at a desired temperature and pressure (e.g., ranging from about 40° to about 150° C. and from about 5 to about 80 psig). By performing the lamination in this manner, it has been observed that the sagging and other deformations of the nozzle plate film 20 into the slots 24 or flow features 30, as occurs with other techniques, is substantially avoided. A hot roll laminator available from Western Magnum Corporation of El Segundo, Calif. under the trade name XRL-120 may be used in this embodiments as the laminator.

In yet another embodiment, and as depicted in FIG. 5, the nozzle plate film 20 is laminated to the substrate/flow feature layer 22/28 by use of a vacuum laminator device 40 having a chamber 42 sealable as by a flexible membrane 44. Heat may be applied to the chamber 42 as by a heating element associated with a floor 46 of the chamber 42. Negative pressure is applied to the chamber 42 as by a vacuum pump in flow communication with the chamber 42 through a vacuum conduit 48. The nozzle plate film 20 is first placed on the floor 46 and the substrate/flow feature layer 22/28 is positioned over the film 20 so that the device side 26 of the substrate 22 is downwardly facing toward the floor 46. The membrane 44 is installed to seal the chamber 42 and heat at a temperature ranging from about 40° to about 150° C. and negative pressure in the range of from about 5 to about 25 inches of mercury are applied to the chamber 42 such that the membrane 44 is forced against the back of the substrate 22 to force the substrate/flow feature layer 28/22 against the film 20 under conditions of heat and pressure and thereby laminate the film 20 to the flow feature layer/substrate 28/22. By performing the lamination in this manner, it has been observed that the sagging and other deformations of the nozzle plate film 20 into the slots 24 or flow feature 30, as occurs with other techniques, is substantially avoided.

In yet another alternative embodiment of the disclosure, the film 20 may be laminated to the substrate/flow feature layer 22/28 in the absence of heat. For example, the film 20 may be placed on a support, such as the plate 32 (FIG. 3). A solvent with solubility parameters ranging from about 17 to about 26 (MPa)^{1/2} is applied to the flow feature layer 28 to render it tacky or adhesive and the substrate/flow feature layer 22/28 is positioned over the film 20 so that the device side 26 of the substrate 22 is downwardly facing. Pressure may then be applied to press the substrate/flow feature layer 22/28 and the film 20 to achieve bonding therebetween in the absence of heat being applied during the bonding purposes. The pressure may be applied by the manners described above with reference to FIG. 3 or 5 or otherwise, it being understood that the orientation is such that the device side 26 of the substrate is substantially downwardly facing.

In this regard, it will be understood that “downwardly” refers to an orientation such that gravitational forces substantially inhibit otherwise unforced movement of the film 20 toward the device side 26 of the substrate 22. As will be appreciated in the case of other methods such as described in connection with FIGS. 1A-1C, the device side of the substrate 4 is oriented to face generally upwardly and gravitational forces result in the observed sagging or deformation of the film toward the slots 10 and flow features 6 in the unsupported areas of the film 8.

To provide a micro-fluid ejection device, the substrate/flow feature layer/nozzle plate film assembly 22/28/20 prepared in accordance with the disclosure may be attached in a well known manner to a chip pocket in a cartridge body to form an ejection head. Fluid to be ejected is supplied to the substrate/flow feature layer/nozzle plate assembly from a fluid reservoir in the cartridge body generally opposite the chip pocket.

The cartridge body can be made of a metal or a polymeric material selected from the group consisting of amorphous thermoplastic polyetherimide available from G.E. Plastics of Huntersville, N.C. under the trade name ULTEM 1010, glass filled thermoplastic polyethylene terephthalate resin available from E. I. du Pont de Nemours and Company of Wilmington, Del. under the trade name RYNITE, syndiotactic polystyrene containing glass fiber available from Dow Chemical Company of Midland, Mich. under the trade name QUESTRA, polyphenylene oxide/high impact polystyrene resin blend available from G.E. Plastics under the trade names NORYL SEl and polyamide/polyphenylene ether resin available from G.E. Plastics under the trade name NORYL GTX. An exemplary polymeric material for making the cartridge body is NORYL SEl polymer.

The semiconductor substrate 22 can be a silicon semiconductor substrate containing a plurality of fluid ejection actuators such as piezoelectric devices or heater resistors formed on the device side 26 of the substrate 22. Upon activation of heater resistors, fluid supplied through the slots 24 in the semiconductor substrate 22 is caused to be ejected through nozzle holes in the nozzle plate film 20. The fluid ejection actuators, such as heater resistors, are formed on the device side 26 of the semiconductor substrate 22 by well known semiconductor manufacturing techniques.

The semiconductor substrate 22 is relatively small in size and typically has overall dimensions ranging from about 2 to about 8 millimeters wide by about 10 to about 20 millimeters long and from about 0.4 to about 0.8 mm thick. The fluid supply slots 24 are typically grit-blasted in the semiconductor substrate 22, etched in the substrate 22 by a chemical wet etch technique, or made by a dry etch process selected from reactive ion etching (RIE) or deep reactive ion etching (DRIE), inductively coupled plasma etching, and the like. Such slots 24 typically have dimensions of about 9.7 millimeters long and 0.39 millimeters wide.

The device side 26 of the substrate 22 can also contain electrical tracing(s) from the heater resistors to contact pads used for connecting the substrate 22 to a flexible circuit or a tape automated bonding (TAB) circuit for supplying electrical impulses from a fluid ejection controller to activate one or more of the heaters or other fluid ejection actuators located on the device side 26 of the substrate 22 The flexible circuit or TAB circuit may be attached to the cartridge body as by use of a heat activated or pressure sensitive adhesive. Exemplary pressure sensitive adhesives include, but are not limited to phenolic butyral adhesives, acrylic based pressure sensitive adhesives such as AEROSET 1848 available from Ashland Chemicals of Ashland, Ky. and phenolic blend adhesives such as SCOTCH WELD 583 available from 3M Corporation of St. Paul, Minn. In an exemplary embodiment, the pressure sensitive adhesive has a thickness ranging from about 25 to about 200 microns.

The disclosed embodiments, as set forth therein, can enable attachment of nozzle plate films in a manner that avoids many of the shortcomings of other manufacturing methods thereby providing an advantage over other micro-fluid ejection head manufacturing processes.

Having described various aspects and embodiments of the disclosure and several advantages thereof, it will be recognized by those of ordinary skills that the embodiments are susceptible to various modifications, substitutions and revisions within the spirit and scope of the appended claims.

What is claimed is:

1. A method of making a micro-fluid ejection head structure comprising:
positioning a semiconductor substrate having a fluid feed slot over a nozzle plate film in a bonding orientation therewith such that the substrate overlies the nozzle plate film and the device side of the substrate is substantially downwardly facing so that gravitational forces inhibit deformation of portions of the nozzle plate film toward the device side of the substrate.

2. The method of claim 1 further comprising applying pressure to the semiconductor substrate to urge the substrate toward the nozzle plate film to effect lamination of the nozzle plate film to the overlying substrate.

3. The method of claim 2, further comprising applying heat to facilitate the lamination step.

4. The method of claim 2, wherein the pressure is applied by use of a thermocompression bonder.

5. The method of claim 2, wherein the pressure is applied by use of a pair of rollers.

6. The method of claim 2, wherein the pressure is applied by use of a vacuum laminator.

7. The method of claim 1, wherein the nozzle plate film comprises a dry film photoresist material.

8. The method of claim 1, wherein the flow features are defined on a layer of a photoresist material applied on the device side of the substrate.

9. The method of claim 2, further comprising applying a solvent to the overlying substrate before applying pressure to the substrate.

10. A micro-fluid ejection head structure comprising a semiconductor substrate semiconductor substrate having a fluid feed slot, a flow feature layer attached adjacent a device side of the substrate, and a nozzle plate film laminated to the flow feature layer, wherein during lamination of the nozzle plate film to the flow feature layer, the semiconductor substrate is positioned over the nozzle plate film in a bonding orientation therewith so that substrate and flow feature layer overlie the nozzle plate film and the device side of the substrate is substantially downwardly facing such that gravitational forces inhibit deformation of portions of the nozzle plate film toward the device side of the substrate.

11. The micro-fluid ejection head structure of claim 10, wherein the nozzle plate film comprises a dry film photoresist material.

12. The micro-fluid ejection head structure of claim 10, wherein the flow feature layer comprises a layer of photoresist material applied on the device side of the substrate.

13. A method of bonding a deformable film to a fluid flow structure in order to inhibit blocking of flow paths in the fluid flow structure comprising:
applying the fluid flow structure to the deformable film by substantially downward movement of the fluid flow structure toward the film whereby gravitational forces inhibit deformation of portions of the film into portions of the flow paths of the fluid flow structure; and
bonding the film to the structure.

14. The method of claim 13 further comprising applying pressure to the fluid flow structure to urge the structure toward the film to effect lamination of the film to the overlying structure.

15. The method of claim 14, further comprising applying heat to facilitate the lamination step.

16. The method of claim 14, wherein the pressure is applied by use of at least one of a thermocompression bonder, a pair of rollers, and a vacuum laminator.

17. The method of claim 13, wherein the film comprises a dry film photoresist material.

18. The method of claim 13, wherein the structure includes flow paths defined on a layer of a photoresist material applied to a semiconductor substrate.

19. The method of claim 13, wherein bonding the film to the structure comprises applying a solvent to the structure before applying the structure to the film, and applying pressure to the structure to urge the structure toward the film to effect lamination of the film to the overlying structure.

20. The method of claim 19, wherein the pressure is applied by use of at least one of a pair of rollers and a vacuum laminator.
